(19) United States
(12) Patent Application Publication
(10) Pub. No.: US 2009/0180518 A1
(43) Pub. Date: Jul. 16, 2009

(54) Ultrawideband Radio Transmitting Apparatus, Ultrawideband Radio Receiving Apparatus, And Ultrawideband Radio Transmitting-Receiving Apparatus

(76) Inventors: Satoru Ishii, Chiba (JP); Yasutaka Koike, Chiba (JP); Ryuji Kohno, Kanagawa (JP)

Correspondence Address: QUARLES & BRADY LLP, 411 E. WISCONSIN AVENUE, SUITE 2040, MILWAUKEE, WI, 53202-4497, US

(21) Appl. No.: 12/350,014

(22) Filed: Jan. 7, 2009

(30) Foreign Application Priority Data
Jan. 10, 2008 (JP) 2008-003610

(51) Int. Cl. H04B 1/00

(52) U.S. Cl. 375/130; 375/E01.001

(57) ABSTRACT

A digital data that includes at least two bits is input to a chirp modulation unit. On the basis of either one of these two bits, a frequency variable range is selected as either a frequency variable range between a frequency f1 and a frequency f2, a frequency variable range between a frequency f2 and a frequency f3 (the frequency f3 is the highest, the frequency f2 the second highest, and the frequency f1 the lowest of these three frequencies). On the basis of the other bit, it is selected whether a frequency is swept to a higher frequency or to a lower frequency within the frequency variable range selected by the one of the two bits.

### TECHNICAL FIELD

The present invention relates to an ultrawideband radio transmitting apparatus, an ultrawideband radio receiving apparatus, and an ultrawideband radio transmitting-receiving apparatus.

### BACKGROUND ART

Currently, existing frequency bands are so exhaustively exploited that it is very difficult to allocate unexplored frequency bands to emerging radio communications systems. One way of adapting to such an irrevocable trend is to introduce ultrawideband (UWB) radio and wireless communications technologies (for example, refer to Nikkei Electronics, Feb. 17, 2003: 98-121). The UWB technology is applicable to a ranging system used to detect a distance to a target object and a positioning system used to identify a position of an object (for example, refer to Yukiji Yamauchi, Spread Spectrum Communications. 1st ed. Tokyo: Tokyo Denki University Press, Nov. 20, 1994).

A known UWB radio communications system, which provides a solution to effectively using or re-using limited radio frequency resources, is based upon, for example, monopulse technique (i.e., a radio communications system that uses a monopulse signal), direct sequence spread spectrum (DSSS) technique, and orthogonal frequency-division multiplexing (OFDM) techniques.

One of the drawbacks of these techniques is that it is difficult to implement a device that incorporates UWB communications features in terms of communication path parameters, i.e., a transfer function for spatial propagation and in particular multipath propagation characteristics. In view of the identified drawback, the inventors of the present invention advocated another UWB technique, i.e., a chirp UWB communications system that transmits data on a chirp signal (for details, refer to Japanese Patent Application Laid-Open Publication No. 2006-74609).

However, a problem is found in a hardware device that incorporates the chirp UWB communications system contemplated by the inventor. Even when a hardware device incorporates the latest electronic components and radio communications techniques, it remains technically demanding to ensure sufficient throughput speeds for both an ultrawideband radio transmitting apparatus, i.e., a hardware device required on the transmitting side for generating the chirp signal, and an ultrawideband radio receiving apparatus, i.e., a hardware device required on the receiving side for discriminating the chirp signal. Also, as a matter of course, a ranging system built on the UWB radio communications technology has to ensure enhanced accuracy in ranging.

### SUMMARY OF INVENTION

In view of the above-identified problems, the present invention is to provide techniques that facilitate implementation of a chirp UWB radio communications system and further improve ranging accuracy.

In order to solve the above-identified problems, an ultrawideband radio transmitting apparatus according to one embodiment of the present invention includes a modulation unit that modulates a digital data signal by which digital data composed of a first bit and a second bit is carried. On the basis of information indicated by the first bit, a frequency variable range is selected from the group consisting of a first frequency variable range and a second frequency variable range. On the basis of information indicated by the second bit, it is selected whether a frequency is swept to a higher frequency or lower frequency within the frequency variable range that has been selected by the first bit.

Also, the ultrawideband radio receiving apparatus according to one embodiment of the present invention receives a chirp signal and decodes the digital signal transmitted by the transmitting apparatus. The chirp signal is either an up-chirp signal whose frequency is swept from a predetermined frequency to a higher frequency depending upon the digital data, or a down-chirp signal whose frequency is swept to the higher frequency to the predetermined frequency. The ultrawideband radio receiving apparatus includes (a) a demodulation unit that separates the received chirp signal into a first phase signal and a second phase signal orthogonal to the first phase signal, (b) a memory unit that stores the first phase signal and the second phase signal, (c) a phase correction unit that corrects a phase of the first phase signal and the second phase signal stored in the memory unit, (d) a chirp-direction detecting unit that detects whether the phase-corrected first phase signal and the phase-corrected second phase signal are the up-chirp signal or the down-chirp signal.

In another aspect of the present invention, the ultrawideband radio receiving apparatus receives a direct-sequence-modulated signal that has been generated by modulating the digital signal and decodes the original digital signal. The digital data carried by the digital signal is a concatenated code composed of a first outer code including an inner code having a predetermined bit and a second outer code orthogonal to the first outer code. The digital signal is separated into a first phase signal and a second phase signal. The first phase signal and the second phase signal are each despread by a matched filter depending upon the inner code and summed respectively, and thus a signal indicative of presence or absence of the inner code. The first outer code and the second outer code are detected on the basis of the signal indicative of the presence or the absence of the inner code.

An ultrawideband radio transmitting-receiving apparatus according to the preferred embodiment of the present invention incorporates the ultrawideband radio transmitting apparatus that transmits the digital data carried by the ultrawideband signal and the ultrawideband radio receiving apparatus that receives an ultrawideband signal that is transmitted by another ultrawideband radio transmitting apparatus and decodes the digital data. The ultrawideband radio transmitting apparatus generates a direct-sequence-modulated signal based on the concatenated code composed of the first outer code including the inner code having the predetermined bit and the second outer code orthogonal to the first outer code. The ultrawideband radio receiving apparatus decodes the inner code and detects a time instant at which the inner code was decoded, and decodes the outer code and detects a time instant at which the outer code was decoded.

The ultrawideband radio transmitting apparatus, ultrawideband radio receiving apparatus, and ultrawideband transmitting/receiving apparatus according to the present invention provides techniques for readily implementing a chirp UWB system and effectively improving the ranging accuracy.

### BRIEF DESCRIPTION OF DRAWINGS

These and other objects, features, and advantages of the present invention will become more apparent upon reading of the following detailed description along with the accompanied drawings, in which:

FIG. 1 schematically explains principles of chirp UWB radio communications;

FIG. 2 schematically explains a basic concept of the chirp UWB radio communications according to one embodiment of the present invention;

FIG. 3 is a block diagram of a transmitting apparatus for the chirp UWB radio communications according to the embodiment of the present invention;

FIG. 4 shows a format of a packet for the chirp UWB radio communications according to the embodiment of the present invention;

FIG. 5 shows waveforms of signals related to chirp signal transmission by the transmitting apparatus according to the embodiment of the present invention;

FIG. 6 schematically explains a frequency spectrum for a chirp wave according to the embodiment of the present invention;

FIG. 7 shows codes contained in a preamble according to the embodiment of the present invention;

FIG. 8 is a block diagram of an I/Q signal detecting unit according to the embodiment of the present invention;

FIG. 9 is a block diagram of a symbol detecting unit according to the embodiment of the present invention;

FIG. 10 is a block diagram of a timing detecting unit according to the embodiment of the present invention;

FIG. 11 shows frequencies used in a receiving apparatus according to the embodiment of the present invention;

FIG. 12 shows an intermediate frequency and other related frequency used in the receiving apparatus frequencies and their relationships according to the embodiment of the present invention;

FIG. 13 shows a preferable waveform of I/Q signals;

FIG. 14 shows a waveform of the I/Q signals affected by a frequency offset, and

FIG. 15 explains a concept of ranging according to the embodiment of the present invention.

### BRIEF DESCRIPTION OF DRAWINGS

Embodiments of the present invention will be described below by referring the attached drawings.

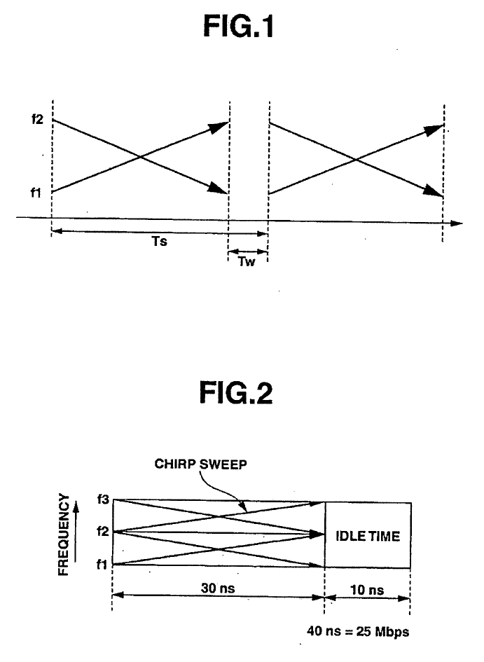

The following describes the basic principles of chirp UWB radio communication with reference to FIG. 1. Referring to FIG. 1, the chirp UWB radio communication is a communication technique that transmits data using a digital signal whose logic one (1) represents a transition of frequency, i.e., a linear frequency sweep from a frequency f1 to a frequency f2 during a predetermined period of time Ts, and logic zero (0) represents a linear frequency sweep from the frequency f2 to the frequency f1 during the time Ts. It should be noted that the association of the two logic values of 1 and 0 with the two modes of frequency sleep is discretionary: It is also possible that the zero and one correspond to the frequency sweep from the frequency f1 to the frequency f2 and from the frequency f2 to the frequency f1, respectively. An idle time Tw shown in FIG. 1 is a period of time reserved for preparation to enter a next state represented by either 1 or 0 and, accordingly, the idle time Tw does not contribute to transmission of data.

The chirp UWB radio communication as such is a known transmission and reception techniques used in a radar and other spread spectrum communications systems. As shown in FIG. 1, a sweep time is defined in units of the time Ts (bit period). Although, in general, the sweep time is defined as being equal to the bit period Ts, this would not be a prerequisite as long as integer relation is maintained between the weep time and the bit period.

Under the technical standards stipulated in the Japanese Radio Law and other related government regulations, the minimum transmission rate (the lowest bit rate) is 50 Mbps. Accordingly, when a burst signal at a half Ts (i.e., a signal transmitted as a chirp signal for which a time equal to a half of the bit period Ts contributes to transmission of data) is to be transmitted, a burst waveform of the chirp signal will be about 100 MHz in frequency terms, and this is considerably fast. One of the reasons for transmitting the signal with the one-half burst may be that, when generating a signal to be transmitted, transition is to be made from the frequency f1 to the frequency f2 for one symbol, and then from the frequency f1 to the frequency f2 for the symbol that immediately follows, then the idle time Tw may be specified as equal to one half of the time Ts in order to ensure that the starting frequency for the next symbol be set to the frequency 1 by making a transition from the frequency f2 to the frequency f1 in advance.

Currently available and inexpensive electronic components are rarely found that are capable of processing a signal having the above-described frequency characteristics. An electronic component that can process a signal conforming to the above frequency characteristics is rarely offered in markets with a moderate price. The chirp UWB radio communications techniques according to the preferred embodiment of the present invention offer a solution to this problem by establishing the chirp UWB radio communications system using two chirp signals to meet the 50-Mbps government regulation and ensure that the currently available components can be used to build the UWB radio communications system, i.e., an ultrawideband radio transmitting-receiving apparatus.

FIG. 2 schematically explains the chirp UWB radio communications system according to the preferred embodiment of the present invention. There are four chirp transition states in this system, i.e., a first transition state representing a case where the frequency sweep as is contemplated in the present invention is made from the frequency f1 to the frequency f2; a second transition state where the frequency sweep is made from the frequency f2 to frequency f1; a third transition state where the frequency sweep is made from the frequency f2 to the frequency f3; and a fourth transition state where the frequency sweep is made from the frequency f3 to the frequency f2. In the chirp UWB system according to the preferred embodiment of the present invention, the time Ts is given as 40 nanoseconds (ns) and the time Tw as 10 ns. While the 50-Mbps requirement is satisfied in the chirp pulse system, throughput speeds of main electronic components are relatively low at 25 Mbps. Thus, a circuit can be developed using currently available components. The preferred embodiment is explained using the chirp signal having the four transition states, which will hereafter be referred to as a four-phase chirp signal.

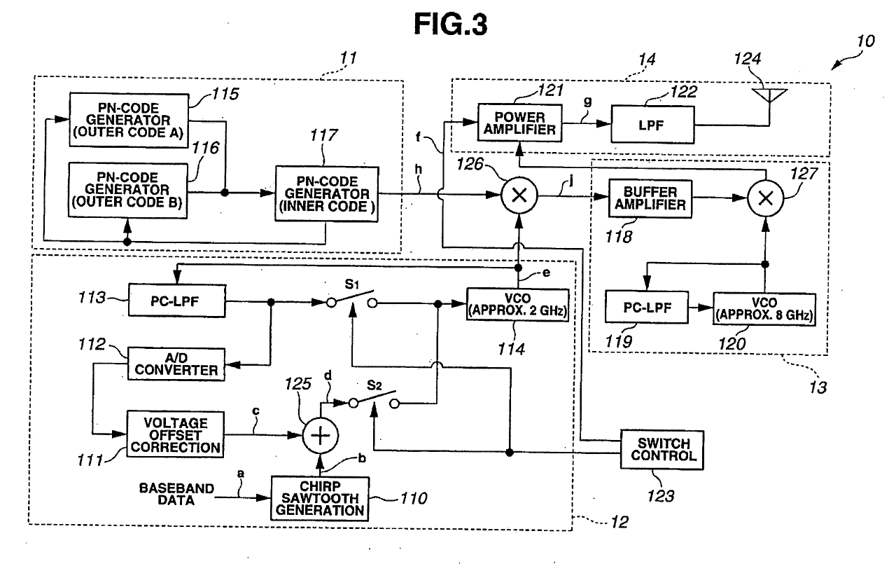

A basic configuration of an ultrawideband radio transmitting apparatus (a transmitting apparatus 10) with chirp UWB radio transmission capability according to the preferred embodiment of the present invention is explained below with reference to FIG. 3.

FIG. 3 is a block diagram of the transmitting apparatus 10 with the chirp UWB radio transmission capability according to the preferred embodiment of the present invention.

The transmitting apparatus 10 includes (a) a PN-code generation unit 11 that generates a pseudorandom noise (PN) code, (b) a chirp modulation unit 12 that modulates a baseband data signal and generates the chirp signal, (c) a multiplier 126 that creates an intermediate frequency, (d) a frequency conversion unit (up-converter) 13 that converts the intermediate frequency into a transmit frequency higher than the intermediate frequency, (e) a power amplification unit 14 that amplifies electric power and limits a bandwidth so that the bandwidth falls always within a range compliant with the government regulations, (f) a broad-band antenna 124 that emits a radio wave based upon a high-frequency electric power that has been amplified by the power amplification unit 14, and (g) a switch control circuit 123 that controls the chirp modulation unit 12 and the power amplification unit 14. The multiplier 126 multiplies a signal sent by the PN-code generation unit 11 by a signal supplied by a VCO circuit 114 of the chirp modulation unit 12.

The PN-code generation unit 11, the chirp modulation unit 12, and the multiplier 126 function as a modulation unit. Also, as will be later described, the PN-code generation unit 11 in some cases outputs the PN code while, in other cases, the PN-code generation unit 11 does not output the PN code.

The PN-code generation unit 11 is a functional block incorporating a PN-code generator 115 that creates a first outer code (Code A), a PN-code generator 116 that creates a second outer code (Code B) orthogonal to the first outer code, and a PN-code generator 117 that creates an inner code. The outer code (Code A), the outer code (Code B), and the inner code will be explained later in this embodiment.

The chirp modulation unit 12 is a functional block that generates the chirp signal in accordance with the digital data carried on the baseband signal which is to be modulated. The chirp modulation unit 12 has a chirp-sawtooth-wave generation circuit 110, a voltage offset compensation circuit 111, an analog-to-digital (A/D) converter 112, a phase-comparison/low-pass-filtering (PC-LPF) circuit 113, a voltage-controlled oscillator (VCO) circuit 114, an adder 125, a switch S1, and a switch S2. A phase-locked loop (PLL) is constituted by the PC-LPF circuit 113 and the VCO circuit 114. The PC-LPF circuit 113 includes a phase comparator (PC), a low-pass filter (LPF), and an oscillation circuit that generates a signal having a predetermined frequency that serves as a reference for phase comparison. Thus, when a PLL feed back loop is enabled (i.e., when the switch S1 is conducted and the switch S2 is disconnected, which will be described later), the predetermined frequency serving as the reference for the phase comparison will be equal to the frequency of the signal that is output by the VCO circuit 114.

The frequency conversion unit 13 has a buffer amplifier 118, a PC-LPF circuit 119, a VCO circuit 120, and a multiplier 127. A phase-locked loop can be constituted by the PC-LPF circuit 119 and the VCO circuit 120. The PC-LPF circuit 119 includes an oscillation circuit that generates a signal having a predetermined frequency that serves as a reference for the phase comparison.

The power amplification unit 14 has a power amplifier 121 and an LPF circuit 122 that ensures that a frequency spectrum of an electric power output by the power amplifier 121 remains within a frequency bandwidth compliant with the government regulations.

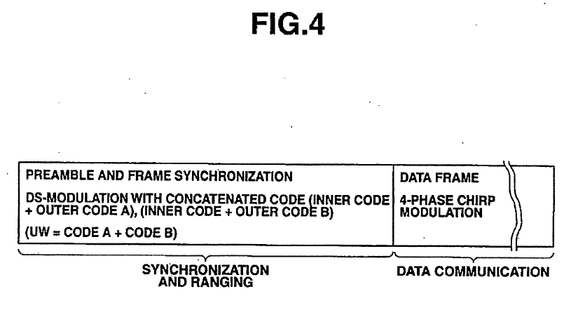

FIG. 4 shows a packet format used in the chirp UWB transmission and reception according to the preferred embodiment of the present invention. As shown in FIG. 4, a packet is constituted by a field that includes (a) a preamble for use in frame synchronization and (b) a data frame. The preamble/frame synchronization field is modulated using a direct-sequence spectrum spreading technique, and the data frame is modulated using the four-phase chirp UWB technique. In terms of the packet format, the operation of the transmitting apparatus 10 involves two operations, i.e., transmission of the chirp signal and transmission of the preamble. When transmitting the chirp signal, the transmitting apparatus 10 employs chirp modulation. When transmitting the preamble field, the transmitting apparatus 10 employs direct sequence spectrum spreading modulation (or simply, DS-modulation). The following describes the operation of transmitting the chirp signal (for the data frame) first, and then the operation of transmitting the preamble, i.e., the field to be DS-modulated.

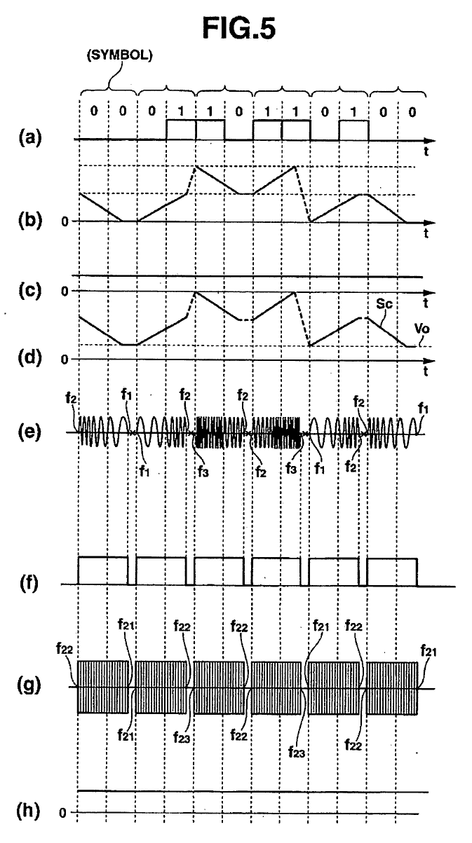

FIG. 5 shows signal waveforms related to transmission of the chirp signal by the transmitting apparatus 10 shown in FIG. 3. The components of the transmitting apparatus 10 described in the foregoing are explained more in detail along with their functionality with reference to FIG. 5.

In FIG. 5, items from the uppermost (a) to the lowermost (h) are the waveforms of the signals that are transmitted via the lines indicated by “a” to “h” in FIG. 3, respectively. For example, the waveform of a baseband signal (a) in FIG. 5 appears at the corresponding portion indicated by “a” in FIG. 3. Each of the horizontal axes for the items (a) to (h) indicates time.

As shown in FIG. 5, the baseband signal (a) is a digital signal representing a baseband data. The baseband signal (a) indicative of time-series baseband digital values is input to the chirp-sawtooth-wave generation circuit 110. One symbol of the baseband data (a) carries two bits of information. As an example, the bits of such a two-bit format may represent information on (i) a frequency range within which the frequency sweep is possible and (ii) a direction of the frequency sweep, respectively. Of course, the correspondence between two pieces of information and the two bits carried by one symbol can be defined in more than one way. For example, the first bit of the two bits of the symbol, i.e., the bit that is first input to the sawtooth wave generation circuit 110, may represent whether the frequency sweep is made between the frequency f1 and the frequency f2, or between the frequency f2 and the frequency f3, while the second bit may represent whether the frequency sweep is made from a lower frequency to a higher frequency (up-chirp) or from a higher frequency to a lower frequency (down-chirp).

Nevertheless, it is possible to reverse the above-correspondence between the first and second bits and the two pieces of information. This means that it is discretionary to define the functions represented by the two bits. Either one of the first bit 2 or the second bit can be the first bit (a bit used to select a frequency range as either an allowable frequency range or another allowable frequency range) and the other can be the second bit (a bit used to select either frequency sweep to a higher frequency or to a lower frequency within the allowable frequency range).

The baseband signal (a) shown in FIG. 5 is a time-series signal. The symbols of the baseband data carried on the baseband signal (a) represent time-series data appearing for example in order of 00, 01, 10, 11, 01, and 00 as shown in FIG. 5. The data of the baseband signal (a) is specified in units of two bits and therefore can be either one of the four states of 00, 01, 10, and 11.

As shown in FIG. 5, a sawtooth-wave voltage (b) generated by the chirp-sawtooth-wave generation circuit 110 can take either one of the four waveforms depending upon the four states of the baseband data (a). More specifically, when the symbol of the baseband data (a) is 00, the waveform corresponds to the second transition state where the frequency sweep is made from the frequency f2 to the frequency f1. When the symbol of the baseband data (a) is 01, the waveform corresponds to the first transition state where the frequency sweep is made from the frequency f1 to the frequency f2. When the symbol of the baseband data (a) is 10, the waveform corresponds to the fourth transition state where the frequency sweep is made from the frequency f3 to the frequency f2. When the symbol of the baseband data (a) is 11, the waveform corresponds to a third transition state where the frequency sweep is made from the frequency f2 to the frequency f3. These states correspond to the sawtooth waves (indicated by a solid line), respectively. A portion of the sawtooth-wave voltage (b) indicated by a dotted line is the portion of the waveform at time Tw preparing for generation of the next sawtooth. A length of the time Ts for one symbol is 40 ns (25 Mbps), and the chirp transmission burst time (a time corresponding to the portion of the sawtooth-wave voltage (b) indicated by the solid line) is 30 ns. During the time Tw (a time corresponding to the portion of the sawtooth-wave voltage (b) indicated by the dotted line), the oscillation frequency of the VCO circuit 114 is set to a starting frequency for a next burst transmission.

Still referring to FIG. 5, an offset compensation voltage (c) is a voltage used to compensate for an offset that occurs in the VCO circuit 114. The offset compensation voltage (c) is obtained in the following manner. First, a switch control circuit 123 shown in FIG. 3 places the switch S1 in a state of conduction, and the switch S2 in a state of disconnection. Thus, the phase-locked loop constituted by the PC-LPF circuit 113 and the VCO circuit 114 is enabled so as to ensure that the frequency of a VCO output wave (e) generated by the VCO circuit 114 is held accurately at a predetermined level, for example, at two gigahertz (GHz). The voltage at this point output by the PC-LPF circuit 113, i.e., a voltage supplied to the VCO circuit 114 while the phase-locked loop of the chirp modulation unit 12 remains effective, is analog-to-digital-converted by the A/D converter 112. An obtained digital value is stored in a storage element of the voltage offset compensation circuit 111. The analog offset compensation voltage (c), which is an analog value corresponding to the above digital value obtained by A/D conversion, is continued to be output by a digital-to-analog (D/A) converter of the voltage offset compensation circuit 111 even when the switch S1 is disconnected and the switch S2 is placed in a state of conduction.

The offset compensation voltage (c) is used to compensate for the offset value of the voltage level of the sawtooth wave when transmitting the chirp signal. By virtue of this compensation, the oscillation frequency of the VCO circuit 114 is kept at a voltage obtained by adding the offset compensation voltage (c) to the sawtooth-wave voltage (b) even when the phase-locked loop is not effective and a state of frequency lock is not entered. The compensated sawtooth-wave voltage (d) allows the chirp signal to be transmitted that has a frequency accurately corresponding to a target center frequency. It should be noted that the switch S1 is turned on and the switch S2 is turned off when transmitting the preamble, and the switch S2 is turned on and the switch S1 is turned off when transmitting the chirp signal.

When transmitting the chirp signal, the offset compensation voltage (c) and the sawtooth-wave voltage (b) are summed by the adder 125 to obtain a compensated sawtooth-wave voltage (d), the compensated sawtooth-wave voltage (d) is input to the VCO circuit 114 to obtain a chirp signal (e) whose frequency changes depending upon the compensated sawtooth-wave voltage (d). The chirp signal (e) is a sinusoid whose frequency linearly changes from one frequency to another over time depending upon the baseband data (a). When the baseband data (a) is 00, the frequency of the signal changes from the frequency f2 to the frequency f1. When the baseband data (a) is 01, the frequency of the signal changes from the frequency f1 to frequency f2. When the baseband data (a) is 10, the frequency of the signal changes from the frequency f3 to the frequency f2. When the baseband data (a) is 11, the frequency of the signal changes from the frequency f2 to the frequency f3. Note that the portion of the chirp wave (e) crossed out by an “x” mark corresponds to the time Tw, during which the frequency is not defined and a transitional signal is generated for transition to the next frequency. In the preferred embodiment, the frequency f1 is specified as 1.875 GHz (2 GHz minus 125 MHz) and the frequency f2 as 2 GHz, and the frequency f3 as 2.125 GHz (2 GHz plus 125 MHz).

The multiplier 126 multiplies the chirp signal (e) by the PN-code output signal (h) output by the PN-code generation unit 11. However, when transmitting the chirp signal, the PN-code output signal (h) is a predetermined voltage that does not exhibit variation over time, and accordingly an intermediate frequency chirp wave (i) is output by the multiplier 126, with a waveform of the intermediate frequency chirp wave (j) identical with that of the chirp signal (e) (the signal (j) is not shown in FIG. 5). The intermediate frequency chirp wave (j) is input to and then output from the buffer amplifier 118, the multiplier 127 multiplies the intermediate frequency chirp wave by a signal having a predetermined frequency (8 GHz) supplied from the VCO circuit 120, and thus a chirp signal having the transmit frequency is obtained and input to the power amplifier 121. The power amplifier 121 generates a chirp signal (g) having the gate-transmit frequency, whose output is masked during a period of time Tw in response to a gate signal (f) supplied from the switch control circuit 123. The LPF 122 performs band limitation for the obtained chirp signal having the gate-transmit frequency. The chirp signal with the gate-transmit frequency is emitted as a radio wave by the broad-band antenna 124. As shown in FIG. 5, the points of the frequencies indicated by f22, f21, and f23 of the chirp signal (g) with the gate-transmit frequency are points of the frequencies at which frequency conversion was made with respect to frequency f2, frequency f1, and frequency f3, respectively.

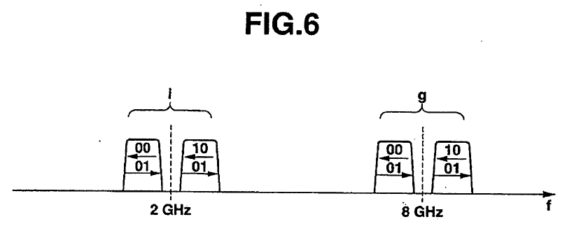

FIG. 6 schematically illustrates the frequency spectra of the intermediate frequency chirp wave (i) and the chirp wave (g) with gate-transmit frequency. In FIG. 6, the down-chirp modulation is represented by arrows accompanying 00 and 10 and indicating change of frequency f from a higher frequency to a lower frequency, while the up-chirp modulation is represented by arrows appearing under 01 and 11 indicating frequency change to a higher frequency.

Since the chirp UWB radio communications system according to the preferred embodiment transmits the chirp signal that can have either of the first to fourth states, transmission only has to be made at a transmission speed of 25 Mbps in order to comply with the minimum bit rate of 50 Mbps set forth in the technical standards. Thus, transmission of the symbols at a low transmission speed has the following advantages:

(1) The analog bandwidth is reduced to half. This is the most significant advantage that further achieves the following effects;
(2) A range of choices for the analog-to-digital converter is expanded, for a high throughput speeds of circuit components is not required that goes beyond a range that can be realized using a conventional inexpensive analog-to-digital converter;
(3) The effects of on/off characteristics of a transmit-burst-signal generation circuit and a length of a transition time upon the circuit are drastically reduced. For example, when a 4-states chirp signal is employed, a required length of the time Tw is an approximately constant length of time determined by a processing time of a hardware device. Even when a 2-states chirp signal is employed, the same length of the time Tw is required as in the case of the 4-states chirp signal. Consequently, given the same transmission bit rate, a longer burst length can be allocated by using two chirp waves (i.e., including information on four states in information to be transmitted) than in a case where only one chirp signal wave is employed (i.e., when information to be transmitted only includes the two states) For example, if a length of the time Tw is 10 ns, the burst length is 10 ns in the case of one chirp signal wave. In contrast, the burst length will be 30 ns when two chirp signal waves are employed.

The features of the transmitting apparatus that transmits the chirp signal according to the preferred embodiment of the present invention can be summarized as follows. The transmitting apparatus according to the preferred embodiment of the present invention has a modulation unit that modulates a digital data signal. The modulation unit includes two main components, i.e., the chirp modulation unit and the multiplier. The digital data has two bits, i.e., the first bit and the second unit. On the basis of the first bit, the modulation unit selects a frequency variable range from a first frequency variable range (for example, a range from the frequency f1 to the frequency f2) and a second frequency variable range (for example, a range from the frequency f2 to the frequency f3). On the basis of the second bit, the modulation unit selects either of up-chirp modulation, i.e., the frequency sweep to a higher frequency and down chirp modulation, i.e., the frequency sweep to a lower frequency within the selected frequency variable range.

The modulation unit may have another configuration as follows: The modulation unit includes a chirp-sawtooth-wave generation circuit that generates a sawtooth wave, a voltage-controlled oscillator (VCO circuit), a phase comparator (PC) that detects a phase difference between the signal output by the voltage-controlled oscillator and a reference signal at a predetermined frequency, a control-voltage generator that generates a control voltage corresponding to the detected phase difference control-voltage generator and a voltage offset compensation circuit that stores the control voltage. In the preferred embodiment, since a signal having the phase difference that has been detected by the phase comparator is filtered by the low-pass filter (LPF) to generate a control voltage, the LPF acts as the control-voltage generator. While the frequency sweep is not performed (for example, when transmitting the preamble, which will be described later), the oscillation frequency of the voltage-controlled oscillator may be controlled through the control voltage supplied from the control-voltage generator. While the frequency sweep is performed (i.e., when transmitting the chirp signal), the signal level of the sawtooth wave may be compensated for by the control voltage stored in the voltage offset compensation circuit.

The signal corresponding to the DS-modulated field (the field including the preamble and for use in frame synchronization as shown in FIG. 4) is obtained by driving the PN-code generation unit 11 shown in FIG. 3 that outputs the PN code and the multiplier 126 that multiplies the carrier wave from the VCO circuit 114 by the PN-code output signal (h) indicative of the PN code and supplied from the PN-code generation unit 11. The multiplier 126 serves as a double-balanced mixer (DBM).

Thus, when the preamble is being transmitted (i.e., when the DS-modulation is performed), the switch S1 is in the state of conduction, and the phase-locked loop circuit constituted by the PC-LPF circuit 113 and the VCO circuit 114 is effective, thereby the frequency of the VCO output wave (e) generated by the VCO circuit 114 is held at a constant level. In this manner, when transmitting the preamble, deviation of frequency between the transmitting apparatus and the receiving apparatus, which will be later discussed in detail, can be reduced to a low level. Also, as has been described above, since transmission of the preamble is performed prior to transmission of the chirp signal, the control voltage level of the VCO circuit 114 when the PLL circuit remains effective is sampled by the analog-to-digital converter 112 and held by the voltage offset compensation circuit 111. The control voltage level is used as the offset compensation voltage (c) when transmitting the chirp signal, and thus a predetermined sweep frequency for the chirp signal can be maintained.

The following describes a concatenated code contained in the DS-modulated field.

A code length of the concatenated code depends upon accuracy of a frequency controlled by the PLL circuit constituted by the PC-LPF circuit 113 and the VCO circuit 114. Practically, given current manufacturing techniques, the level of frequency accuracy of the PLL circuit can be in the order of plus or minus 5 ppm between the transmitting apparatus and the receiving apparatus when the transmitting apparatus and the receiving apparatus are each equipped with the phase-locked loop circuits independent form each other. For example, if the center frequency is eight (8) GHz, then the 5 ppm corresponds to 40 kHz. If a permissible amount of phase rotation of an I/Q signal (to be described later) is not greater than 45 degrees, then the available length of the concatenated code can be in the order of 3.125 microseconds.

For example, if the chip rate is 500 Mcps, the code length of the concatenated code in the above time of 3.125 microseconds will be in the order of 1,500 chips. In other words, when a length of the inner code is given as 10 to 20 chips, displacement of the frequency (i.e., carrier slip) occurring between the transmitting apparatus and the receiving apparatus while the inner code is transmitted and received will affect normal operation of transmission and reception only to a negligible degree. The length of the outer code within the 125-microsecond range is to be specified as in the order of 75 inner codes which corresponds to 1500 chips at maximum. In the embodiment, the code length is specified as 31 inner codes which is readily compatible with use of an Maximum length sequence (M-sequence) outer code.

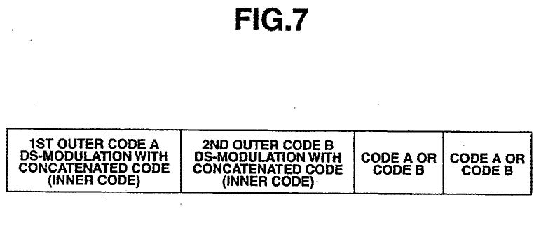

FIG. 7 is a format of the preamble according to the preferred embodiment of the present invention. The preamble is composed of the inner code and the outer code for stable ranging and bit timing detection. In other words, as the code for the DS-modulation is the concatenated code that includes the outer code and the inner code. Data modulated by the direct-sequence spectrum spreading technique is created using a first outer code (code A) and a second outer code (code B). The first outer code (code A) is generated by the PN-code generator 115. The second outer code (code B) is generated by the PN-code generator 116.

The first outer code (code A) and the second outer code (code B) are orthogonal to each other. On the side of a receiving station, two different matched filters are used, which handles detecting (decoding) of the specific outer codes, respectively. The first outer code (code A) and the second outer code (code B) constitute one unique word (UW), and a bit string is formed in units of unique words by associating bit “1” of the UW with the first outer code (code A) and bit “0” with the second outer code (code B). The unique word (UW) is for use in frame synchronization and judgment of a coarse position in the ranging. Note that it is also possible to associate the bits 0 and 1 of the unique word with the first outer code (code A) and the second outer code (code B), respectively.

For example, the inner code for the bit synchronization is a Barker sequence with a code length of 11. The outer code for frame synchronization is a Gold sequence code with the code length of 31. For example, in this embodiment, if the chips of a pseudo-random noise (PN) sequence are {C1, C2, . . . C11} for “0” of the inner code, the chips of the PN sequence are {C1*, C2*, . . . C11*} for “1” of the inner code, wherein C1* has a sign different from that of C1, C2* has a sign different from that of C2, and C11* likewise has a sign different from that of C11. Also, “1” for each of the chips constituting the outer code corresponds to “1” of the inner code, and “0” for each of the chips constituting the outer code corresponds to “0” of the inner code. As explained above, the first outer code (code A) and the second outer code (code B) are orthogonal to each other.

Features of the transmitting apparatus that transmits the preamble signal according to the preferred embodiment of the present invention can be summarized as follows. The transmitting apparatus has a modulation unit that generates a direct-sequence-modulated signal (DS-signal). The main components of the modulation unit are a code generation unit and a multiplier. The modulation unit generates the DS-signal using the concatenated code composed of the first outer code having an inner code that includes a predetermined bit and the second outer code orthogonal to the first outer code (and yet the inner code is the same as that contained in the first outer code). As has been described above, it is possible to use two different signals by combining the transmitting apparatus configured to transmit the preamble signal of this kind and another transmitting apparatus configured to transmit the chirp signal.

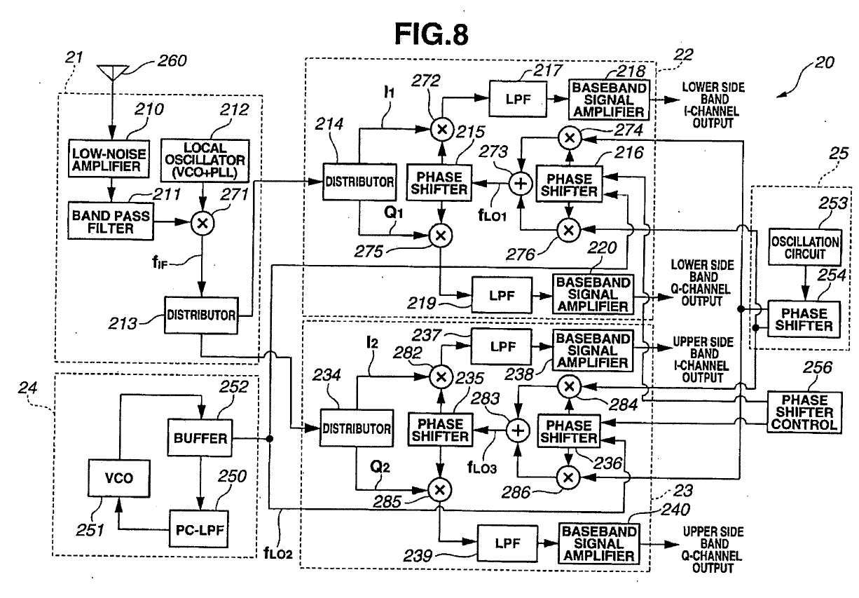

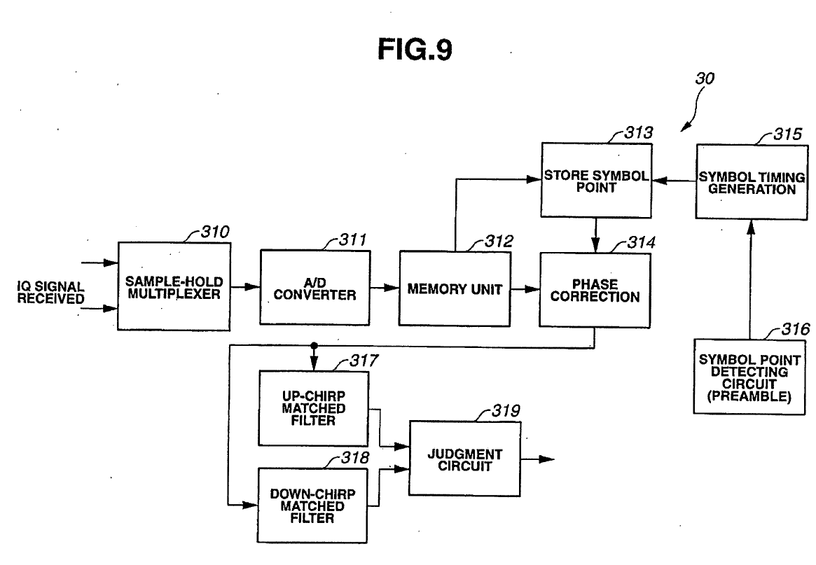

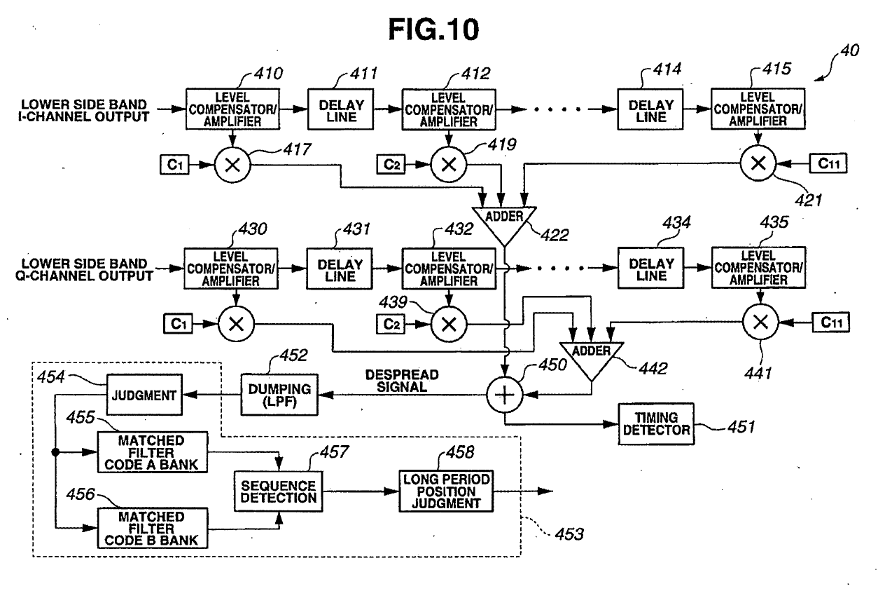

FIGS. 8 to 10 illustrate functional blocks and components of the ultrawideband radio receiving apparatus (simply called “receiving apparatus”) capable of the chirp UWB radio communications according to the preferred embodiment of the present invention. FIG. 8 is a block diagram of an I/Q signal detecting unit 20. FIG. 9 is a block diagram of a symbol detecting unit 30. FIG. 10 is a block diagram of a timing detecting unit 40. The I/Q signal detecting unit 20, the symbol detecting unit 30, and the timing detecting unit 40 constitutes the receiving apparatus according to the preferred embodiment of the present invention. Also, the receiving apparatus, which includes these functional blocks, and the transmitting apparatus 10 (refer to FIG. 3) pertain to the same chirp UWB communications system according to the preferred embodiment of the present invention.

The I/Q signal detecting unit 20 receives a radio wave transmitted by the transmitting apparatus 10 shown in FIG. 3 and obtains I/Q-signals, i.e., an in-phase signal and an quadrature signal. The symbol detecting unit 30 obtains a symbol signal of the data frame. The timing detecting unit 40 obtains the PN code in the preamble, a bit synchronization signal, and a frame synchronization signal.

It should be noted that a communications apparatus that incorporates the transmitting apparatus 10 and the receiving apparatus (including the I/Q signal detecting unit 20, the symbol detecting unit 30, and the timing detecting unit 40) is a ultrawideband radio transmitting-receiving apparatus (simply called “transmitting-receiving apparatus) that has both of the ultrawideband transmission features and the ultrawideband reception features according to the preferred embodiment of the present invention.

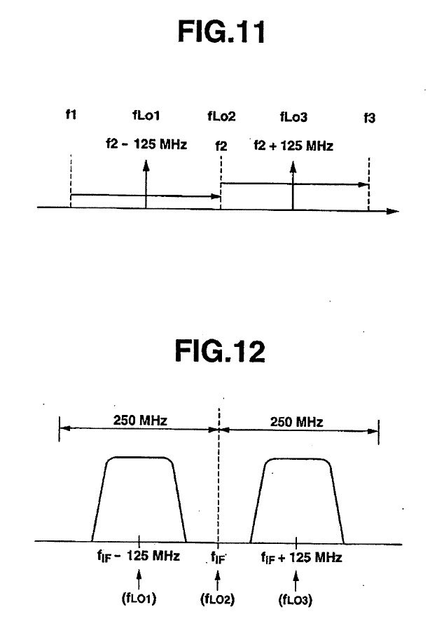

The following describes components and modes of operation of the I/Q signal detecting unit 20 in detail with reference to FIGS. 8 and 11. The I/Q signal detecting unit 20 has an intermediate frequency conversion unit 21, a first I/Q demodulation unit 22, a second I/Q demodulation unit 23, a local-frequency oscillation unit 24, and a conversion-frequency oscillation unit 25. The most important functional blocks of the I/Q signal detecting unit 20 are the first I/Q demodulation unit 22 that detects lower-side defined by the frequency f1 and the frequency f2 and the second I/Q demodulation unit 22 that detects a upper-side defined by the frequency f2 and the frequency f3.

FIG. 11 shows relationships of the frequency f1, the frequency f2, the frequency f3, a frequency fLo1, a frequency fLo2, a frequency fLo3, and a frequency fLo4. Before embarking on the illustration of detailed features of the I/Q signal detecting unit 20, let us overview the features of operation performed by the I/Q signal detecting unit 20 with reference to FIG. 11.

The I/Q signal detecting unit 20 shown in FIG. 11 is a cost-performance-oriented solution to implementing an ultrawideband receiving apparatus. As illustrated in FIG. 11, the I/Q signal detecting unit 20 does not have three separate oscillation units that are each dedicated to generating local signals for baseband demodulation having the frequency fLo1, the frequency fLo2, and the frequency fLo3. Instead, the I/Q signal detecting unit 20 has one and only one oscillation unit that generates the local signal with the frequency fLo2. The I/Q signal detecting unit 20 employs an image rejection mixing technique and virtually generates two additional local signals having the frequency fLo1 and the frequency fLo3, respectively. In this manner, intended functionality can be achieved without using three PLL circuits and cost-effectiveness as an integrated system can also be improved.

Since details of the image rejection mixing will be described later, it will suffice here to sketch an outline of it. When a signal with a specific frequency is multiplied by another signal with a different specific frequency, three signals are created including an original carrier wave, an upper-side-band signal, and a lower-side-band signal. When a 90-degree phase shift is performed for each of the signals with two different frequencies, two quadrature signals are obtained. Then, two multiplication operations are performed for each pair of the in-phase and quadrature signals. By summing the results of the two operations, one single signal with a frequency in either a tower-side-band or a higher-side-band can be obtained.

Also, the receiving apparatus and the transmitting apparatus 10 operate asynchronously with simplified circuit configurations. The receiving apparatus including the I/Q signal detecting unit 20, the symbol detecting unit 30, and the timing detecting unit 40 and the transmitting apparatus 10 are driven by two independent clock signals. When demodulating a received signal, the received signal with the frequency fLo2 is first input and the timing detecting unit 40 obtains a symbol point information out of the preamble. For the data frame, for each chirp frequency range, a signal that corresponds to the baseband signal is obtained on the basis of the four signals of the in-phase signal with the lower-side-band frequency, the quadrature signal with the lower-side-band frequency, the in-phase signal with the higher-side-band frequency, and the quadrature signal with the higher-side-band frequency. In this manner, data contained in the preamble and the data frame can be decoded.

A radio wave is received by a broad-band antenna 260 and input to the intermediate frequency conversion unit 21. In the intermediate frequency conversion unit 21, the signal that has been received by the broad-band antenna 260 is amplified by a low-noise amplifier 210 and, after having been filtered by a bandpass filter (BPF) 211, input to a multiplier 271. The signal input to the multiplier is multiplied by a signal that is supplied from a local oscillator 212 and input to the multiplier 271. Thus, the signal that was detected by the broad-band antenna 260 is converted into an intermediate frequency signal fIF. The intermediate frequency signal fIF is a modulated signal. The intermediate frequency signal fIF is distributed by the distributor 213 and is input to the first I/Q demodulation unit 22 and the second I/Q demodulation unit 23, respectively.

The first I/Q demodulation unit 22 detects a lower-side-band I-channel output and a lower-side-band Q-channel output. Meanwhile, the second I/Q demodulation unit 23 detects an upper-side-band I-channel output and an upper-side-band Q-channel output. Note that the first I/Q demodulation unit 22 and the second I/Q demodulation unit 23 basically have the same configuration.

The intermediate frequency signal fIF that has been input to the first I/Q demodulation unit 22 via the distributor 213 is further distributed by a distributor 214 into a signal II and a signal Q1. A signal fLO1 with a frequency of fLO1 (fIF minus 125 MHz) is applied to a phase shifter 215. An in-phase signal having the same phase as that of the signal fLO1 is output on one side of the phase shifter 215 and input to the multiplier 272, and a quadrature signal that is 90 degrees out of phase with respect to the signal fLO1 is output on the other side of the phase shifter 215 and input to the multiplier 275.

The signal fLO1 is acquired as an output by an image rejection mixer that runs in accordance with the above-described principles. The image rejection mixer is constituted by an adder 273, a phase shifter 216, a multiplier 274, and another multiplier 276. A signal with a single frequency identical with the intermediate frequency fIF is output by the local-frequency oscillation unit 24 and input to the phase shifter 216. Also, a signal output by a phase shifter control circuit 256 is input to the phase shifter 216.

Signals with a single frequency of 125 MHz are output by the conversion-frequency oscillation unit 25 and input to the multiplier 274 and the multiplier 276, respectively. The phase shifter 254 ensures that the signal input to the multiplier 274 is 90 degrees out of phase with respect to the signal input to the multiplier 276. In addition, the phase shifter control circuit 256 ensures that a signal that is output on one side of the phase shifter 216 is 90 degrees out of phase with respect to a signal that is output on the other side of the phase shifter 216. A signal that has been output by the multiplier 274 and a signal that has been output by the multiplier 276 is summed by the adder 273 and thus a signal fLO1 is acquired and output by the adder 273.

The local-frequency oscillation unit 24, which generates the signals input to the phase shifter 216 and the phase shifter 236, includes a phase-locked loop circuit that can be constituted by a PC-LPF circuit 250, a VCO circuit 251, and a buffer 252. Thus, a signal with a frequency fLO2 is generated by the phase-locked loop circuit of the local-frequency oscillation unit 24.

The signal output by the multiplier 272 is filtered by a low-pass filter (LPF) circuit 217 and then amplified by a baseband signal amplifier 218. Thus, the lower-side-band I-channel output signal is acquired. Likewise, the signal output by the multiplier 275 is filtered by a low-pass filter (LPF) circuit 219 and then amplified by a baseband signal amplifier 220. Thus, a lower-side-band Q-channel output signal is acquired.

The intermediate frequency signal fIF that has been input via the distributor 213 to the second I/Q demodulation unit 23 is further distributed by the distributor 234 into two signals, i.e., a signal 12 and a signal Q2. A signal fLO3 with a frequency of fIF plus 125 MHz is applied to a phase shifter 235. An in-phase signal having the same phase as that of the signal fLO3 is output on one side of the phase shifter 235 and input to a multiplier 282, and a quadrature signal that is 90 degrees out of phase with respect to the signal fLO3 is output on the other side of the phase shifter 235 and input to a multiplier 285.

The signal fLO3 is acquired as an output by the image rejection mixer. The image rejection mixer is constituted by an adder 283, a phase shifter 236, a multiplier 284, and another multiplier 286. A signal with the frequency fLO2 is output by the local-frequency oscillation unit 24 and input to the phase shifter 236. Also, a signal output by the phase shifter control circuit 256 is input to the phase shifter 236.

Signals with a frequency of 125 MHz are output by the conversion-frequency oscillation unit 25 and input to the multiplier 284 and the multiplier 286, respectively. The phase shifter 254 ensures that the signal input to the multiplier 284 is 90 degrees out of phase with respect to the signal input to the multiplier 286.

The phase shifter control circuit 256 controls the phase shifter 236 so that a signal output by the local-frequency oscillation unit 24 and input to the multiplier 284 is 90 degrees out of phase with respect to a signal input to the multiplier 286. A signal that has been output by the multiplier 284 and a signal that has been output by the multiplier 286 is summed by the adder 283 and thus a signal fLO3 is acquired and output by the adder 283.

FIG. 12 schematically illustrates relationships of the intermediate frequency signal fIF, the signal fLO2, the signal fLO1, and the signal fLO3.

The signal output by the multiplier 282 is filtered by a low-pass filter (LPF) circuit 237 and then amplified by a baseband signal amplifier 238. Thus, an upper-side-band I-channel output signal is acquired. Likewise, the signal output by the multiplier 285 is filtered by a low-pass filter (LPF) circuit 239 and then amplified by a baseband signal amplifier 240. Thus, an upper-side-band Q-channel output signal is acquired.

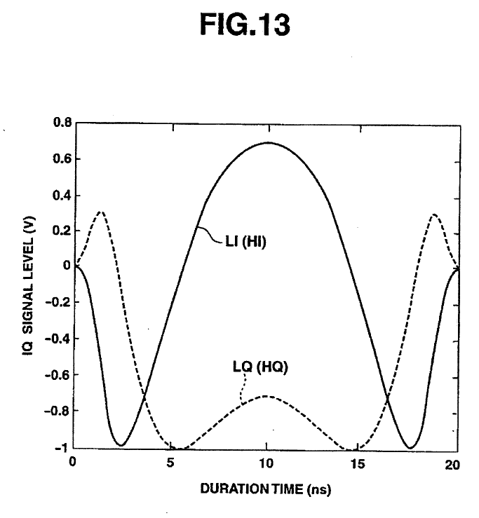

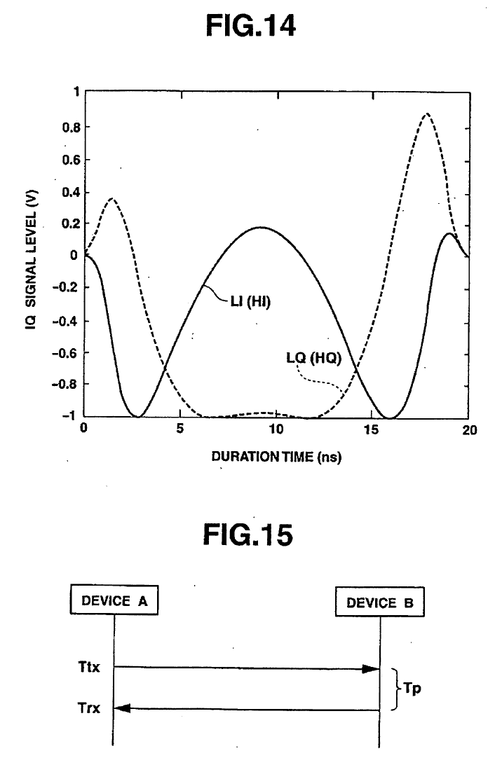

In this manner, in order to judge (decode) the symbol carried on the received chirp signal again in terms of four values, it is necessary to discriminate up-chirp modulation and down-chirp modulation with respect to each of the lower-side-band in-phase and quadrature signals and the upper-side-band in-phase and quadrature signal. However, since the frequency on the side of the transmitting station and the frequency on the side of the receiving station are not synchronized with each other, a typical waveform illustrated in FIG. 13 or FIG. 14 will be obtained by simple I/Q signal separation that extracts the in-phase and quadrature signals. FIG. 13 illustrates ideal waveforms of the in-phase and quadrature signals. In contrast, FIG. 14 illustrates waveforms of the in-phase and quadrature signals in a case where 10 MHz of a frequency offset (carrier slip) occurs. It is difficult to detect the I/Q signal when a chirp state continues for a long period of time. However, since the duration of the chirp state is short in the preferred embodiment, the in-phase and quadrature signals can be successfully detected.

Also, as discussed in the foregoing, even when a phase rotation occurs, the inner code can be detected out of either the lower-side-band or I-channel output or the lower-side-band Q-channel output, as a result of which the symbol point can also be detected. This is why the transmitted data can be decoded on the side of the receiving station even when the transmitting apparatus and the receiving apparatus operate asynchronously with respect to each other and the carrier slip occurs.

If the In-phase signal and the quadrature signal have such waveforms as are shown in FIG. 14, it is difficult to correctly decode the symbol that has been transmitted from the transmitting apparatus 10. In the preferred embodiment, in order to obtain the ideal waveforms of the in-phase and quadrature signals, the preamble is used for the bit synchronization and the frame synchronization, so that the symbol point is correctly extracted and the ideal I/Q signal waveform shown in FIG. 13 can be obtained. More specifically, the symbol detecting unit 30, based on the preamble, generates a symbol timing in reception, so that each symbol point can be extracted with accuracy.

FIG. 9 is a block diagram of the symbol detecting unit 30 that performs symbol discrimination according to the preferred embodiment of the present invention. The following describes the symbol detecting unit 30 with reference to FIG. 9. The symbol detecting unit 30 is a circuit that obtains the lower-side-band I-channel output signal and the lower-side-band Q-channel output signal. The same (or similar) circuit configuration as that shown in FIG. 13 also applies to a circuit (not shown) for obtaining the higher-side-band in and quadrature signals (i.e., the circuit that obtains the higher-side-band I-channel output signal and the higher-side-band Q-channel output signal).

The symbol detecting unit 30 has a sample-and-hold multiplexer circuit 310, an analog-to-digital (A/D) converter 311, a memory unit 312, a symbol point storing unit 313, a phase correction unit 314, a symbol timing generation unit 315, a symbol point detecting circuit 316, a matched filter 317, a matched filter 318, and a judgment circuit 319.

The sample-and-hold multiplexer circuit 310 multiplexes the lower-side-band 1-channel output signal and the lower-side-band Q-channel output signal. The A/D converter 311 performs analog-to-digital conversion for the lower-side-band I-channel output signal and the lower-side-band Q-channel output signal through oversampling at a rate equal to an integral multiple of an original sampling rate. The A/D-converted lower-side-band I-channel output signal and the A/D-converted lower-side-band Q-channel output signal are serially stored in the memory unit 312. The memory unit 312 has a FIFO structure and the stored digital signals are erased in a chronological order. The sample-and-hold multiplexer circuit 310 is provided in order that one and only one A/D converter 311 has to be used. Accordingly, the sample-and-hold multiplexer circuit 310 can be omitted if analog-to-digital conversion is performed using two analog-to-digital converter units, or more specifically four A/D converters when those for the upper-side-band I/Q output signals are taken into account.

The digital data stored in the memory unit 312 in a first-in-first-out manner contains a symbol in a case where appropriate synchronization has been achieved and oversampled time-series symbol data preceding and following the symbol at the appropriate synchronization. Also, as discussed above, if each symbol cannot be detected with a proper phase, i.e., if the phase rotation occurs due to the carrier slip (see FIG. 14), it is necessary to ensure that each symbol can be detected with the proper phase (see FIG. 13). For correction of the phase rotation, the symbol point storing unit 313 stores the symbol point data and the phase correction unit 314 corrects an amount of phase rotation for each symbol point stored in the memory unit 312 on the basis of the symbol point data that has been supplied from the symbol point storing unit 313. More specifically, for phase correction by the phase correction unit 314, information on the symbol points is stored in the symbol point storing unit 313 with respect to the symbol point data of the signal data which are stored in the memory unit 312 and are arranged in accordance with the time series of the symbol data. On the basis of the amount of phase rotation (amount of displacement of the phase) stored in the symbol point storing unit 313, the phase is corrected signal data stored in each of the storage elements of the memory unit 312. Thereafter, the corrected phase data are delivered to the matched filter 317 and the matched filter 318.

The process of the phase correction is more fully discussed below. Since the transmitting station's frequency and the sending station's frequency are not synchronized with each other, the phase rotation occurs due to the carrier slip as shown in FIGS. 13 and 14. Information on the signals having the waveforms shown in FIG. 14 as a result of the phase rotation are oversampled with the symbol point being the center of sampling point and is stored in the memory unit 312. As shown in FIG. 14, the data stored in the memory unit 312 are uniformly affected by the phase rotation. Since the original phase of the stored data at the symbol point is zero, the phase of the stored signal data at the symbol point (which is stored in the symbol point storing unit 313) is a difference with respect to the original phase (zero phase). This means that the phase of the signal data stored in the memory unit 312 is corrected by a value obtained by reversing a sign of the phase information stored in the symbol point storing unit 313 and using the sign-reversed value as a correction value. The amount of phase to be corrected is stored at a time instant that corresponds to the symbol point that has been detected by the symbol point detecting circuit 316. More specifically, the symbol point detecting circuit 316 corresponds to a timing detector 451 (to be described later) shown in FIG. 10. Referring to FIG. 10, when detecting the inner code, a point at which a result of addition by an adder 450 is the largest is defined as a reference timing, on the basis of which a timing that corresponds to the actual symbol point is created.

Signal extraction is performed in a maximum-likelihood manner by the digital matched filters 317 and 318 based on the shapes of the in-phase signal and the quadrature signal and a filter shape. The matched filter 317 is the up-chirp matched filter dedicated to symbol detection for up-chirp signals. The matched filter 318 is a down-chirp matched filter dedicated to symbol detection for down-chirp signals. The judgment circuit 319 judges whether the signal that has been filtered and output by the matched filter 317 is larger or smaller than the signal that has been filtered and output by the matched filter 318, and thus performs a maximum-likelihood detection so as to judge whether the signal is an up-chirp signal or a down-chirp signal. In this manner, it is possible to accurately decode the symbol data carried on the lower-side-band (frequency f1 to frequency f2) in-phase signal and quadrature signal.

Another circuit with the same circuit configuration as the symbol detecting unit 30 shown in FIG. 9 for the lower-side-band I/Q signals is also provided for processing the upper-side-band I/Q signals. By virtue of the upper-side-band symbol detecting unit, the symbol data can also be accurately decoded with respect to the upper-side-band (frequency f2 to frequency f3) I/Q signals.

The matched filter 317 and the matched filter 318 are both configured as a transversal filter.

The up-chirp signal is the chirp signal whose frequency changes from a predetermined frequency to a higher frequency (for example, from the frequency f1 to the frequency f2, or from the frequency f2 to the frequency f3). Meanwhile, the down-chirp signal is the chirp signal whose frequency changes from a higher frequency to a predetermined frequency (for example, from the frequency f2 to the frequency f1, or from the frequency f3 to the frequency f2). It depends upon the digital data signal to me modulated whether the chirp signal received by the receiving apparatus is the up-chirp signal or the down-chirp signal.

The receiving apparatus capable of receiving the chirp signal with the configuration described above can be summarized as follows according to the preferred embodiment of the present invention. The receiving apparatus receives the chirp signal which can be either the up-chirp signal or the down-chirp signal and decodes the received chirp signal to obtain the decoded digital signal. The receiving apparatus includes the demodulation unit that separates the chirp signal into the first phase signal (I-channel output signal) and the second phase signal (Q-channel output signal) that is orthogonal to the first phase signal; the memory unit that stores the first phase signal and the second phase signal; the phase correction unit that corrects the phases of the first phase signal and the second phase signal that are stored in the memory unit; and a chirp-direction detecting unit (including the up-chirp matched filter, the down-chirp matched filter, and the judgment circuit) that detects whether the phase-corrected first phase signal and the phase-corrected second phase signal are the up-chirp signal or the down-chirp signal.

The phase correction unit may be controlled based on the information contained in the preamble of the received chirp signal. Also, the demodulation unit may have the image rejection mixing circuit.

With regard to the detection of bit timing in the chirp UWB transmission and reception envisaged in the preferred embodiment of the present invention, the preamble is DS-modulated for detection of the bit timing, and, as has been explained above, the code used in the preamble is provided as the concatenated code so that the timing synchronization between the transmitting apparatus and the receiving apparatus is possible even when the frequencies of the transmitting apparatus and the receiving apparatus are not synchronized. Also, the DS-modulated field, i.e., the preamble, is demodulated on the side of the receiving station to obtain the bit timing.

The following describes the demodulation of the DS-signal. FIG. 10 is a block diagram of the timing detecting unit 40 of the receiving apparatus. The timing detecting unit 40 has a matched filter that demodulates the DS-modulated field of the DS-signal. The matched filter of the timing detecting unit 40 employs an analog delay element so that the digital sampling rate does not act as a constraint on the timing detection. Although the block diagram of the timing detecting unit 40 is with regard to a case where the DS-signal is demodulated on the I/Q lower side band, this does not raise a problem, for the local oscillation frequency input to this circuit in this case is fLO2.

The timing detecting unit 40 has four matched filters, two of which are configured to despread the inner code and detect a bit clock signal. The other two matched filters are configured to despread the outer code and obtain a frame synchronization signal. The matched filters for detecting the bit clock signal are constituted by 22-stages of filters, one of the matched filters being 11-staged and dedicated to the lower-side-band I-channel output signals and the other being 11-staged and dedicated to the lower-side-band Q-channel output signals. FIG. 10 illustrates processing starting from the first tap, the second tap, and thus finally the eleventh tap. The third to tenth taps are not shown in FIG. 10.

The configuration of the tap stages of the matched filter for detecting the bit clock signal is as follows. For the lower-side-band I-channel output signal, the first tap is constituted by a level compensator/amplifier 410 and a coefficient multiplier 417. The second tap is constituted by a delay line 411, a level compensator/amplifier 412, and a coefficient multiplier 419. The third to tenth taps of the matched filter, which are not shown in FIG. 10, are likewise each constituted by a delay line, a level compensator/amplifier, and a coefficient multiplier. A coefficient C1 is a tap coefficient for the first stage, the coefficient C2 is the tap coefficient for the second stage, and likewise the coefficient C11 is the tap coefficient for the eleventh stage. As has been described above, the third to tenth stages of the matched filter that are not shown in FIG. 10 have the tap coefficients C3 to C10, respectively. Note that the coefficients of the matched filter comply with the same principles as in the case of the coefficients of the PN-code generator 117 used to spread the inner code.

The stages of the matched filter used to detect the bit clock signal has the same configuration as described above for the lower-side-band Q-channel output signal. The first stage is constituted by a level compensator/amplifier 430 and a coefficient multiplier 437. The second stage is constituted by a delay line 431, a level compensator/amplifier 432, and a coefficient multiplier 439. The third to tenth stages of the matched filter, which are not shown in FIG. 10, are likewise each constituted by a delay line, a level compensator/amplifier, and a coefficient multiplier.

A signal output by an adder 422 and a signal output by an adder 442 are summed by an adder 450 and the inner code is detected (decoded) by a timing detector 451. More specifically, the timing detector 451 detects whether or not the signal output by the adder 450 exceeds a predetermined threshold having a sign of either plus or minus. This means that, if a sequence of the inner code is either of 1 and 0, a bit synchronization signal depending upon the sequence is acquired by the timing detector 451. Also, a time instant at which the bit synchronization signal is generated is detected and the time instant is used to measure a fine distance in ranging operation which will be later described).

The following describes decoding of the outer code. A short pulse of the inner code that has been detected with high accuracy is subjected to dumping by a low-frequency dumping circuit 452, which is provided as a low-pass filter (LPF), and thus a duration of the pulse is expanded. A pulse output with the expanded duration can be converted into a digital signal by a digital signal processing unit 453 that uses a low-frequency clock signal. The digital signal processing unit 453 has an outer-code-detection feature and includes a judgment unit 454, matched filter unit 455, a matched filter unit 456, both of these filters being configured as a digital filter, a sequence detecting unit 457, and a long-period-position judgment unit 458.

A signal that is input to the judgment unit 454 in accordance with the amount of phase rotation of the I/Q signal can assume a value with either plus or minus. This means that it is not possible to judge whether the code at the time when transmission was made was 1 or 0 for the inner code that has been decoded by the receiving apparatus. It is only possible to detect the difference of the signs of the code. In view of this, the judgment unit 454 detects a positive or negative peak of the inner code and the peak value is input to the matched filter unit 455 and the matched filter unit 456. The matched filter unit 455 and the matched filter unit 456 has orthogonal properties with respect to each other. Either of these two matched filter units can obtain correlation for a digital signal input. Such circuit configuration is capable of readily obtaining signal correlation without a serious problem raised due to absence of clock synchronization between the transmitting apparatus and the receiving apparatus. In this manner, the signal correlation can be readily detected even when a phase of the inner code rotates by 180 degrees due to the phase rotation. The sequence detecting unit 457 detects two outer code sequences and detects the frame synchronization signal. Also, the long-period-position judgment unit 458 identifies a time instant at which the frame synchronization signal was detected. The time instant is used in measurement of the fine distance in the ranging operation (to be described later).

A tap coefficient of the matched filter 455 is made equal to the tap coefficient of the PN-code generator 115. A tap coefficient of the matched filter 456 is made equal to the tap coefficient of the PN-code generator 116. The signal that has been spread by the transmitting apparatus is despread by the receiving apparatus.

The receiving apparatus that receives the direct-sequence signal (DS-signal) generated on the basis of the digital signal according to the preferred embodiment can be summarized as follows. The receiving apparatus receives the concatenated code, which is carried on the digital signal and is constituted by the first outer code having the inner code including the predetermined bit and the second outer code (having the same inner code) orthogonal to the first outer code. The demodulation unit separates the digital signal into the first phase signal (the in-phase signal output on the I-channel) and the second phase signal (the quadrature signal output on the Q-channel) that are orthogonal to each other. The first phase signal and the second phase signal that have been despread by the matched filters corresponding to the inner code are summed to detect existence or absence of the inner code. The first outer code and the second outer code are detected based on a signal indicative of the existence or absence of the inner code.

UWB radio communications technology allows ranging simultaneously performed with actual radio communications. The term “ranging” means measurement of a distance between two objects. In the preferred embodiment, as explained in the foregoing, the preamble is DS-modulated using the direct-sequence code in a form of the concatenated code so that the ranging can be performed with high accuracy. The following describes a concept of the ranging. Note that a time-of-arrival (TOA) based ranging is described in the preferred embodiment.

FIG. 15 explains basics of the TOA-based ranging. The ranging is performed in the following manner.

(1) A transmitting station (device A) transmits a packet. At this point, a preamble transmission timing Ttx is stored for example in a memory unit.
(2) A receiving station (device B) receives the packet transmitted by the transmitting station and, after an internal processing time Tp has elapsed, transmits a reply packet.
(3) The transmitting station stores a reception timing Trx at which synchronization has been established based upon a preamble of the reply packet sent by the receiving station.
(4) The above steps 1 to 3 are repeated to obtain a transmission time, which does not include the internal processing time Tp, from the transmitting station (device A) to the receiving station (device B). Further, the transmission time is multiplied by a light speed to perform the ranging (distance estimation).

The measurement of the transmission time should be explained more specifically. Time instants at which a peak output of the inner code was generated are detected by the timing detector 451 (see FIG. 10) and arranged in a time-series sequence. It is measured at which chip in a chronological order the peak has been detected. Thus, it is made possible to measure a time elapsed until the inner code transmitted by the transmitting station (device A) and serving as the bit synchronization signal is again received by the transmitting station (device A), and the ranging of the fine distance is performed on the basis of the above-described time measurement. Further, by using chip timing of the outer code, it is made possible to measure the time elapsed until the outer code transmitted by the transmitting station (device A) and serving as the frame synchronization signal is again received by the transmitting station (device A) to perform ranging of a coarse distance. Finally, a result of the ranging of the fine distance and a result of the ranging of the coarse distance is combined to realize high-accuracy long-distance ranging.

Meanwhile, if a difference of internal clock signals for use in time measurement is large between the transmitting station (device A) and the receiving station (device B), an error in the internal processing time Tp becomes large on the side of the receiving station (device B), causing a larger measuring error in the measurement of the transmission time. In such a case, a double token exchange TOA (DTOA) technique allows the measurement of the transmission time to be performed only using the time measurement clock signal without being affected by the error on the side of the receiving station (device B). The DTOA is a technique according to which two rounds of a TOA sequence are performed twice to eliminate influence of the internal processing time of the receiving station (device B).

Obviously, the time instant of transmission of the inner code by the transmitting station (device A) and the time instant of transmission of the outer code by the transmitting station (device A) can be identified by the transmitting station (device A). Also, the time instant at which the transmitting station (device A) receives the inner code that has been retransmitted from the receiving station (device B) can be identified on the basis of the time instant that is detected by the timing detector 451 (see FIG. 10) of the transmitting station (device A). The time instant at which the transmitting station (device A) receives the outer code that has been retransmitted from the receiving station (device B) can be identified on the basis of the time instant that is detected by the long-period-position judgment unit 458 (see FIG. 10) of the transmitting station (device A).

Since the maximum bandwidth is 500 MHz as defined by the technical standards stipulated in the Japanese Radio Law for the entire transmission frequency spectrum, the chip rate of the direct-sequence spectrum spreading can be up to 500 chips per second (cps) and the accuracy of ranging can be dozens of centimeters, or several centimeters in a case of high-accuracy ranging.

The distance that can be detected using the inner code is explained, assuming that the length of the inner code is 20 chips and the chip rate is 500 Mbps. The length of the repeatedly performed distance resolution is given as 3×108×20/500×106=12(m). When this length is exceeded, the distance repeats within the range of 0 to 12 m, and an accurate distance fails to be detected. Meanwhile, the length of distance resolution for repetition that can be detected using the outer code and further using the unique word (UW) will be 12×20=240 (m) when the length of the outer code is specified as 20 inner codes.

As has been described above, accurate ranging is achieved by combining the distance finely measured and detected using the inner code and the distance coarsely measured and detected using the outer code and the unique word.

In the preferred embodiment, as illustrated in FIG. 4, the data frame is modulated using the four-phase chirp UWB technique. The data frame can also be modulated using the direct sequence modulation technique according to the preferred embodiment, though the transmission bit rate will be lower. More specifically, when information contained in the data frame is transmitted using the inner code only, it is difficult to decode an ultrawideband signal by a demodulation technique using the in-phase signal and the quadrature signals. Nevertheless, when the concatenated code having the inner code and the outer code is employed, decoding can be successfully performed using the in-phase and quadrature signals, which allows the data frame to be modulated by the direct sequence technique envisaged in the preferred embodiment.

The transmitting apparatus according to the preferred embodiment of the present invention has the following advantageous features.

The chirp UWB radio communications techniques allow transmitting-receiving apparatus with relatively simple circuit configurations to be used to build an ultrawideband radio communications system capable of handling the ultrawideband signal. Also, the chirp UWB radio communications techniques are relatively multipath-tolerant, and accordingly, the chirp UWB techniques are also suitable for industrial applications that require high reliability even under poor communication conditions including multipath interference, i.e., signal attenuation and distortion due to multipath propagation. Also, in the preferred embodiment, two chirp signals having different frequency ranges are employed and, two states of the frequency sweep, i.e., the state where frequency sweep is made to a higher frequency and the state where the frequency sweep is made to a lower frequency, are defined for each of the chirp signals. These four states are associated with the two bits of the symbol, and processing per one symbol can be made at a low throughput speed, thus allowing currently available electronic components with currently achievable throughput speeds to be used to realize the chirp UWB radio communications system.

Also, prior to transmission of the symbol data, a period of time for initial setting of the frequency of the VCO circuit (for example, a time dedicated to transmission of the preamble) is defined. During the initial setting time, transmission is performed with the frequency of the VCO circuit locked by enabling the phase-locked loop and the control voltage that controls the oscillation frequency of the VCO circuit during the initial setting time is stored as the offset compensation voltage. When transmitting the chirp signal, the sawtooth-wave voltage is compensated by the offset compensation voltage, thus allowing the chirp signal to be transmitted with an accurate frequency, so that carrier slip can be minimized between the transmitting apparatus and the receiving apparatus whose frequency is not synchronized with that of the transmitting apparatus transmitting the chirp signal.

Further, the UWB radio communications based on the direct-sequence spectrum spreading techniques allows high-accuracy ranging. In particular, since the preamble is modulated using the direct-sequence spectrum spreading techniques while the data frame is modulated using the chirp UWB techniques, greater synergy is expected. First, since the synchronization timing that has been detected out of the preamble can be used in phase correction when receiving the chirp signal, the symbol phase offset in receiving the chirp signal can be compensated for. In particular, since the code used in the direct-sequence modulation is the concatenated code having the inner code and the outer code, the receiving apparatus can readily achieve the bit synchronization using the inner code and the frame synchronization using the outer code, and thus the decoding of the data frame that has been transmitted is facilitated. Also, the period of time for the initial setting of the frequency of the VCO circuit can be specified depending upon or corresponding to the time of transmission of the preamble.

In addition, accurate ranging can be achieved by the transmitting apparatus capable of the chirp UWB radio communications based on the direct-sequence modulation using the concatenated code. By using the inner code for ranging of a relatively small distance, and the outer code for ranging of a relatively long distance, the distance to be measured in the ranging can be expanded and at the same time the accuracy of can be improved.

The transmitting-receiving apparatus capable of performing the ranging according to the preferred embodiment of the present invention can be summarized as follows. The transmitting-receiving apparatus has a transmitting apparatus that transmits the digital data on the ultrawideband signal and a receiving apparatus that receives the ultrawideband signal transmitted by the transmitting apparatus and decodes the digital data. The transmitting apparatus generates a direct-sequence signal using the concatenated code constituted by the first outer code expressed by the inner code that includes a predetermined bit and the second outer code that is orthogonal to the first outer code. Also, the receiving apparatus decodes the inner code and detects the time instant at which the inner code is decoded, and decodes the outer code and detects the time instant at which the outer code is decoded. By using two transmitting-receiving apparatuses with the above configuration and features, the accurate ranging is readily achieved in a facilitated manner.

The receiving apparatus according to the preferred embodiment of the present invention has the following advantageous features.

The receiving apparatus converts the received signal into the in-phase signal and the quadrature signal for decoding of the received signal. This means that the decoding of the received signal can be achieved without synchronizing the frequency of the receiving apparatus with that of the transmitting apparatus. In particular, when receiving the signal with the preamble that contains the concatenated code having the inner code and the outer code, the received signal is decoded to obtain the bit synchronization based on the inner code and the frame synchronization based on the outer code. Further, the symbol phase displacement is corrected for the chirp signal that has been converted into the in-phase and quadrature signals on the basis of the synchronized signals. The corrected data are decoded by maximum-likelihood decoding using the matched filters.

The transmitting-receiving apparatus according to the preferred embodiment of the present invention has the following advantageous features.

The transmitting-receiving apparatus according to the preferred embodiment uses two chirp signals with different frequency ranges and defines four states of frequency sweep i.e., a state where the frequency sweep (chirp) is made to a higher frequency and a state where the frequency sweep is made to a lower frequency, for each of the two chirp signals. By associating these four states with the value of the two-bit symbol, processing per a symbol can be performed at a low throughput speed, thus achieving the transmission of the chirp signal with simple circuit configuration. Also, The chirp signal output by another transmitting apparatus or another transmitting-receiving apparatus is converted into the in-phase and quadrature signals and the signals are filtered by the matched filter and decoded by maximum-likelihood decoding. This allows good communication performance between the transmitting-receiving apparatuses that operate asynchronously with each other.

The transmitting-receiving apparatus according to the preferred embodiment of the present invention performs data transmission by direct-sequence modulation using the concatenated code having the inner code and the outer code suited for ranging purposes, and decodes the inner code and the outer code out of the direct-sequence-modulated signal. Ranging can be achieved by a ranging system including a first transmitting-receiving apparatus and a second transmitting-receiving apparatus that is spatially distant from the first transmitting-receiving apparatus. More specifically, the first transmitting-receiving apparatus transmits a signal, and the second transmitting-receiving apparatus receives the signal and then starts transmission of a signal, and the first transmitting-receiving apparatus receives the signal transmitted by the second transmitting-receiving apparatus. Further, the first transmitting-receiving apparatus uses the matched filter and detects the first time instant at which the signal by the inner code is at a peak thereof, and detects the fine distance on the basis of a difference between the detected peak time and the time instant at which the first transmitting-receiving apparatus started transmission. In addition, by using the outer code and based on the same principles, the transmitting-receiving apparatus performs the detection of a larger distance and thus measures the spatial distance between the first transceiver and the second transceiver.

Having now fully described the device according to the preferred embodiment of the present invention, it is clear that the foregoing is illustrative of the present invention and is not to be construed as limiting the invention. The ultrawideband radio transmission techniques (a set of techniques related to the transmitting apparatus and such transmission technology), the ultrawideband radio reception techniques (a set of techniques related to the receiving apparatus and such reception technology), and the ultrawideband radio communications techniques (a set of techniques related to the transmitting-receiving apparatus and such transmission/reception technology) can be combined as required depending upon applications and usage. For example, the technique of using the chirp signal in radio communications and using the direct-sequence-modulated signal for ranging purposes is mere a combination of the specific techniques and all of the numerical values that appear in the preferred embodiment are only intended as typical non-limiting examples. Those skilled in this art, accordingly, will readily effectuate possible modifications and variations without materially departing from the spirit and scope of the present invention.

1. An ultrawideband radio transmitting apparatus comprising a modulation unit for modulating a digital signal carrying digital data, wherein said modulation unit receives a unit of the digital data including a first bit and a second bit, selects a frequency variable range from the group consisting of a first frequency variable range and a second frequency variable range based on the first bit, and, selects whether a frequency is swept to a higher frequency or to a lower frequency within the frequency variable range based on the second bit.

2. The ultrawideband radio transmitting apparatus according to claim 1, wherein the modulation unit comprises:
a chirp-sawtooth-wave generation circuit that generates a sawtooth wave;
a voltage-controlled oscillator;
a phase comparator that detects a phase difference between a reference signal at a predetermined frequency and a signal output by the voltage-controlled oscillator;
a control-voltage generator that generates a control voltage in response to the phase difference, the control voltage controlling an oscillation frequency of the voltage-controlled oscillator during a period of time in which the frequency is not swept; and
a voltage offset compensation circuit that stores the control voltage, the control voltage stored in the voltage offset compensation for use in compensation of a signal level of the sawtooth wave during a period of time in which the frequency is swept.

3. The ultrawideband radio transmitting apparatus according to claim 1, wherein the modulation unit generates a direct-sequence-modulated signal by using a concatenated code comprising a first outer code including an inner code having a predetermined bit and a second outer code orthogonal to the first outer code.

4. The ultrawideband radio transmitting apparatus according to claim 3, wherein the modulation unit creates a preamble that includes a unique word constituted by the first outer code and the second outer code.

5. In an ultrawideband radio receiving apparatus for receiving a chirp signal, the chirp signal being either an up-chirp signal whose frequency is swept from a predetermined frequency to a higher frequency or a down-chirp signal whose frequency is swept from the higher frequency to the predetermined frequency depending upon a digital data carried by a digital signal and decodes the digital signal, the ultrawideband radio receiving apparatus comprising:
a demodulation unit for separating the chirp signal into a first phase signal and a second phase signal orthogonal to the first phase signal;
a memory unit for staring the first phase signal and the second phase signal;
a phase correction unit for correcting a phase of the first phase signal and the second phase signal that are stored in the memory unit; and
a chirp-direction detecting unit for detecting whether the phase-corrected first phase signal and the phase-corrected second phase signal are the up-chirp signal or the down-chirp signal.

6. The ultrawideband radio receiving apparatus according to claim 5, wherein the phase correction unit is controlled in accordance with information contained in a preamble of the received chirp signal.

7. The ultrawideband radio receiving apparatus according to claim 5, wherein the demodulation unit includes an image rejection mixing circuit.

8. An ultrawideband radio receiving apparatus for receiving and decoding a direct-sequence-modulated signal generated based on a digital signal, wherein the digital signal comprises a concatenated code that includes a first outer code including an inner code having a predetermined bit and a second outer code orthogonal to the first outer code; separates the received digital signal into a first phase signal and a second phase signal orthogonal to the first phase signal; identifies a signal indicative of presence or absence of the inner code by despreading both of the first phase signal and the second phase signal by a matched filter that corresponds to the inner code and summing the first and second phase signals that have been despread; and detects the first outer code and the second outer code on the basis of the signal indicative of the presence or the absence of the inner code.

9. An ultrawideband radio transmitting-receiving apparatus comprising an ultrawideband radio transmitting apparatus that transmits an ultrawideband signal carrying a digital data, the ultrawideband radio transmitting apparatus being configured to generate a direct-sequence-modulated signal by using a concatenated code comprising a first outer code including an inner code having a predetermined bit and a second outer code orthogonal to the first outer code; and an ultrawideband radio receiving apparatus that receives an ultrawideband signal transmitted by an ultrawideband radio transmitting apparatus and decodes the ultrawideband signal carrying the digital data, the ultrawideband radio receiving apparatus being configured to decode the inner code and detect a time instant at which the inner code is decoded, and decode the outer code and detect a time instant at which the outer code is decoded.
